(19) United States
(12) Patent Application Publication
(10) Pub. No.: US 2021/0084883 A1
(43) Pub. Date: Mar. 25, 2021

(54) SYSTEM FOR MOUNTING AN OVITRAP

(71) Applicants: TIMOTHY AMYAS HARTNOLL, Binjai Park (SG); ERICH JOHANN DOLLANSKY, Jawa Tengah (ID); SUMARNI ., Jawa Tengah (ID)

(72) Inventors: TIMOTHY AMYAS HARTNOLL, Binjai Park (SG); ERICH JOHANN DOLLANSKY, Jawa Tengah (ID); SUMARNI ., Jawa Tengah (ID)

(21) Appl. No.: 17/040,670

(22) PCT Filed: Mar. 21, 2019
(86) PCT No.: PCT/SG2019/050156

§ 371 Date: Sep. 23, 2020

(30) Foreign Application Priority Data
Mar. 23, 2018 (SG) 10201802407T

(51) Int. Cl. A01M 1/10

(52) U.S. Cl. CPC A01M 1/106

(57) ABSTRACT

A system for mounting an ovitrap is described which allows an ovitrap to be reliably and removably secured in desired locations. The system includes a frame arranged to hold a removable container, the container arranged to hold a liquid and collect the eggs of water-breeding insects, and a retainer configured to secure the container within the frame. The retainer is configured to move between: a closed position, in which the retainer extends towards and grips the container when the container is in the frame; and an open position, in which the retainer is withdrawn from the container, allowing the container to be removed from the frame. The container can be removably secured within the frame and held in the correct orientation by one or more retainers which prevent the container being dislodged. The retainer can be moved to the open position allowing the container to be removed from the frame.

### RELATED APPLICATION INFORMATION

This patent claims priority from International PCT Patent Application No. PCT/SG2019/050156, filed Mar. 21, 2019 entitled, “SYSTEM FOR MOUNTING AN OVITRAP”, which claims priority to Singapore Patent Application No. 10201802407T, filed Mar. 23, 2018, both of which are incorporated herein by reference in their entirety.

NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### BACKGROUND

### Field of the Invention

The present invention relates to system for mounting an ovitrap, in particular a system for mounting a replaceable ovitrap which facilitates a simple and cost-effective method of controlling water-breeding insects like mosquitoes.

### Background of the Invention

Some 1.5 million people die every year as a result of a mosquito bite. The World Health Organization considers mosquito control as a critical element of any mosquito-borne disease prevention.

The effectiveness of any method using chemical agents is dropping more and more. This is proven by the world-wide rise of mosquito-related fatalities.

One known method for managing the population of mosquitos and other water-breeding insects in the use of ovitraps. An ovitrap is a device in which water-breeding insects can lay their eggs which prevent the development of the eggs into mosquitos. An ovitrap generally includes a container containing water and optionally a substrate where insects can lay their eggs. An ovitrap is used to attract water breeding insects like mosquitoes to deposit their eggs into it. Depending on the insects, the eggs might be deposited on the walls of the ovitrap near the water surface or directly onto the water surface itself. Larvae will emerge after some time out of the eggs. The larvae will develop over time into pupae and finally into the adult insect. The presence of water is essential for the development of the insect. Emptying the ovitrap before the adult insect emerges disrupts the development cycle as the already developed larvae and/or pupae will be either removed together with the other content of the ovitrap or dry out and die. As such, the insect which deposited its eggs into the ovitrap dies without off-spring, thereby reducing the number of new adult insects which can spread diseases.

An ovitrap can be either a permanent ovitrap or a temporary ovitrap. A permanent ovitrap is installed permanently at a location. A temporary ovitrap can easily be moved between locations. The concept of automatic lethal ovitraps was introduced in PCT application PCT SG 2007 000137. Such traps may be permanently installed and have automated functionality such that they can carry out certain tasks automatically, for example, filling the container with liquid to a desired level and emptying the container when required to destroy collected insect eggs.

The concept of autonomous mosquito control using water filled containers introduced with the Singaporean patent application 10201800869Y. In particular, replaceable ovitraps can be distributed over an area where the population of insects is to be managed and the distributed ovitraps can be managed, for example by moving, replacing and refilling the containers of the ovitraps. These management tasks can be attended to by using a system in which autonomous vehicles are instructed to carry out these simple management tasks.

However problems still exist in how to effectively install the ovitraps at desired locations. The containers can often move out of a desired position for example due to the effects of weather or being knocked or otherwise disrupted by animals or humans in the area. Accordingly there exists a need to provide a system for mounting ovitraps which overcomes some of these problems of the prior art.

### SUMMARY OF THE INVENTION

According to the present invention there is provided a system for mounting an ovitrap comprising a frame arranged to hold a removable container within the frame, the container arranged to hold a liquid and collect the eggs of a water-breeding insect; a retainer configured to secure the container within the frame, wherein the retainer is configured to move between: a closed position, in which the retainer extends towards and grips the container when the container is in the frame; and an open position, in which the retainer is withdrawn from the container, allowing the container to be removed from the frame.

The system for mounting an ovitrap according to the present invention therefore provides a system in which the liquid-carrying container of an ovitrap can be removably secured within a supporting frame such that it can be held in the correct orientation by the one or more retainers which provide sufficient grip to prevent the container being dislodged. Furthermore, when the container is to be refilled or replaced, as must be carried out regularly, the retainer can be moved to the open position allowing the container to be removed from the frame. By providing retainers which can be selectively moved between an open and a retaining configuration, an ovitrap can be mounted securely and reliably between refilling, replacing or otherwise managing the maintenance of the ovitrap.

The term “retainer” is used to refer to a feature which can mechanically secure the container within the frame. Preferably the retainer is provided by a clip or latch mechanism.

The frame provides a structure in which the ovitrap can be positioned such that it is held in a specific orientation, i.e. in an orientation in which a liquid can be held with an opening exposed to allow water-breeding insects to pass into the container to deposit their eggs. Preferably the frame can be positioned on any surface or secured to a surface or structure.

Preferably the frame comprises: an upper opening arranged to receive the container; and a lower support surface arranged to support the container from below when received through the upper opening. In this way the container can simply be lowered into the frame such that it is supported by the frame in the required orientation. This allows for the container to be replaced in a straightforward manner with not adjustment to the frame, other than movement of the retainer, allowing management of the ovitrap to be carried out by an autonomous vehicle.

Preferably the frame comprises a substantially annular side wall defining the upper opening, with sloping internal side walls such that the internal cross section of the frame decreases with distance from the upper opening. In this way, no significant alignment of the container need be carried out when lowering it into the frame. A wider opening may be provided which may be easily located with the angled inner walls guiding the container into the received position on the supporting surface as it is lowered into the opening.

Preferably the system further comprises a container arranged to hold a liquid and collect the eggs of a water-breeding insect, the container comprising a groove extending at least partially around an outer side wall of the container; wherein: in the closed position, the retainer extends into the groove of the container to prevent a container from being removed from the frame; and in the open position, the retainer is withdrawn from the groove of the container, allowing a container held in the frame to be removed.

In this way, a secure means to retain the container is provided, the extension of the retainer into the groove preventing substantial vertical movement of the container when the retain is in the closed position. In particular, a portion of the retainer may move between the open and closed position in a substantially radial direction relative to the container (that is substantially perpendicularly to the insertion direction of the container) such that the retainer moves towards the side of the container and enters the groove in the container side wall. Preferably multiple retainers are provided around the circumference of the container to prevent lateral movement of the container (within the confines of the frame) as well as the above-described vertical movement.

Preferably the groove is a circumferential groove running around the circumference of the outer side wall of the container. This means that no rotational alignment of the container is required to align the retainers relative to groove, reducing the complexity of replacing a container, facilitating the performance of the method by an autonomous vehicle.

Preferably in the closed position, the container is secured between the lower support surface of the frame and the contact between the retainer and the groove. This limits downward movement of the container through the frame by contact of the base with the supporting surface of the frame and limits upward movement by contact between the retainer and lower surface of the groove, thereby securing the container.

Preferably the groove is positioned at a sufficient height on the side wall of the container such that the groove is exposed above the frame when the container is held in the frame such that it can be accessed by a holding tool to remove the container from the frame.

Preferably the retainer comprises a protrusion arranged to extend into the groove of the container when the retainer is in the closed position; and an elastic body configured to bend when an outward force is applied to move the protrusion out of the groove in the open position, the elastic body biased to return to the closed position when the force is removed. This provides a straightforward means of providing the movement between the open and closed position (under the elastic deformation of the retainer body) but ensures the retainer returns to the closed position. This simplifies the removal procedure since a single force must be applied to remove the retainer from the groove before it returns to the retained position. This helps in facilitating the carrying out of the method by an autonomous vehicle.

Preferably the body of the retainer comprises an attachment arranged to secure the retainer to an outer surface of the frame near the base of the frame, the elastic retainer body extending upwards from the base of the frame along an outer surface of the frame; and the protrusion is arranged such that it extends over the frame to engage with the groove when a container is held in the frame; wherein the retainer body is arranged to bend outwards about the attachment from the closed position to the open position. This provides a simple way to attach the retainer to the frame and distances the protrusion (at an upper portion of the retainer) from the attachment point (at a lower portion of the retainer) such that minimal outward force near the upper portion of the retainer provides increased displacement of the protrusion from the groove.

Preferably the container comprises a groove on two opposing outer sides and the system comprises two retainers, each arranged to engage with the groove on an opposing outer side of the container, the system further comprising: a lifting tool comprising two arms arranged to pass either side of the container to enter the grooves on the opposing sides of the container such that the container can be lifted out of the frame via the engagement of the arms of the lifting tool with the grooves of the container; wherein the system is arranged such that when the tool is moved into engagement with the grooves, the arms of the tool are brought into contact with the retainers to apply an outward force to the retainers to move them into the open position. In this way, the retained container may be removed in a straightforward manner as a lifting tool simultaneously moves the retainers to the open position and engages with the groove to allow the container to be lifted out of the frame. The groove on two opposing sides may be provided by a single circumferential groove.

Preferably the protrusion of the retainer occupies only a portion of the total height of the groove when in the closed position, thereby leaving a gap configured such that the arms of the lifting tool can enter the grooves alongside the protrusions. The gap may be positioned above the protrusion, below the protrusion or between the protrusion and the adjacent container side wall.

Preferably the arms of the lifting tool each comprise an angled end arranged to meet the retainer when the lifting tool is moved into the grooves of the container within the frame, the angled ends arranged to increasingly displace the retainers as the arms of the lifting tool are advanced into the grooves to progressively bend the retainers into the open position. The angled surface provides a wedge effect in which the thin end of the wedge enters the groove first, the angled surface acting to guide the retainer body away from the container as the arms are progressed into the grooves.

Preferably the protrusion has an angled upper surface arranged such that a base of the container meets the angled surface as the container is lowered into the upper opening of the frame, the angled upper surface arranged such that continued movement of the container into the frame increasingly displaces the retainer to move the retainer into the open position such that the container can be received within the frame. In this way a human or automated vehicle does not need to actively move the retainers the open position to lower the container into the frame but instead in simply lowering the container in, the angles faces are such so as to cause the retainers to move to allow placement of the container.

In some embodiments of the invention the system further comprises an actuator, wherein the retainer is configured to move between the closed and open position upon actuation of the actuator. In this way, the actuator must be actuated in order to move the retainers to the open position rather than this happening automatically on engaging the groove with a holding tool. This increases the security with which the container is retained.

Optionally the actuator is a button or switch configured to move the retainer between the closed and open position upon contact with the button or switch or alternatively or additionally the actuator is a connector to which a connection may be established to provide instruction to move the protrusions between the closed and open positions. Where the actuator is a connector configured to provide for electrical signals to be transmitted to the connector, the connector may be configured to connect via contact or via wireless connection with a corresponding connection on an autonomous vehicle; wherein the connection is configured to receive instructions from the autonomous vehicle to move the protrusions between the closed and open positions. The actuator may be arranged to be actuated by an autonomous vehicle or a human operator.

In a further aspect of the invention there is provided a mounting system for an ovitrap comprising: a frame arranged to hold a container, the frame comprising an upper opening for receiving the container and a lower surface for supporting the container when received in the upper opening; one or more elastic retainers, the retainers biased into a closed position in which the retainers grip the outer walls of a container when received in the frame, the retainers configured to bend when an outward force is applied to move the retainers away from the container to allow the container to be removed. The provision of elastic retainers to secure the container provides a straightforward and reliable means for a container to be removed from the container under a single action. That is, by simply engaging the container in a way that provides an outward force on the retainers, the container may be removed from the container.

The system may further comprise an autonomous vehicle configured to grip and move the container such that the container can be replaced by the autonomous vehicle.

The system may further comprise a holding tool comprising two arms arranged to pass either side of the container to enter the grooves on the opposing sides of the container; wherein the autonomous vehicle is configured to use the holding tool to lift the container out of the frame in order to replace the container.

The frame may be configured to fixedly attach to a surface. For example it may contain attachment means to allow the frame to be attached to a floor surface or a wall or other support such that ovitraps may be positioned in a range of differing locations and orientations. In certain examples the frame is configured to fixedly attach to a beam to allow the ovitrap to be mounted in an elevated position. In the latter case the system may further comprise a tube arranged to be installed in a wall such that an end of the tube extends freely from the wall; and a beam having a first end configured to fixedly attach to the frame and a second end, opposite to the first end, which is arranged to slide into the free end of the tube to support the ovitrap in an elevated position.

### DESCRIPTION OF THE DRAWINGS

The invention will be described with reference to the following figures.

FIG. 1 illustrates a container.

FIG. 2 illustrates a frame to hold a container.

FIG. 3 illustrates a tool to hold a container.

FIG. 4 illustrates a clip to hold a container into position.

FIG. 5 illustrates a container held into position inside a frame by two clips in a sectional side view.

FIG. 6 illustrates a container held into position inside a frame by two clips in a view from top.

FIG. 7 illustrates a container held into position inside a frame by two clips and a tool to remove the container in a view from top.

FIG. 8 illustrates a container held into position inside a frame by two clips and a tool to remove the container in a view from side.

FIG. 9 illustrates a container held by a tool over a frame with clips.

FIG. 10 illustrates a frame with a connector.

FIG. 11 illustrates a frame with container inserted and held into position by two latches.

FIG. 12 illustrates a frame with container inserted and released from its position.

FIG. 13 illustrates a house with a container inside in a sectional side view.

FIG. 14 illustrates a house for a container from the side with the door to access the container inside the house.

FIG. 15 illustrates a frame with holder attached in a side view.

FIG. 16 illustrates a frame with a holder attached to a tube in a side view.

FIG. 17 illustrates tubes in a wall in a front view.

FIG. 18 illustrates a tube in a wall in a side view.

FIG. 19 illustrates a frame connected via a holder and a set of tubes to a wall.

### DETAILED DESCRIPTION

The system for mounting an ovitrap according to the present invention includes a removable container arranged to hold a liquid and collect the eggs of a water-breeding insect and a frame arranged to hold the container within the frame. In order to secure the container to the frame, the system further includes a retainer configured to move between: a closed position, in which the retainer extends towards and grips the container when in the frame; and an open position, in which the retainer is withdrawn from the container, allowing the container to be removed. This allows a replaceable container to be securely fastened within a frame by using the retainer, while allowing it to be removed with ease when it needs to be replaced or refilled. In particular, the removal or replacement of a container can be performed in a straightforward manner such that it can be performed by an autonomous vehicle.

The invention facilitates the autonomous management of distributed ovitraps. The system allows for a container to be securely fastened within a frame with the retainer which prevents the contents spilling. The retainer is also straightforward to remove by a human or more preferably an autonomous vehicle. Therefore frames can be installed across a region in which the population of a water breeding insect is to be managed. Containers can then be placed in the frames and secured in place with the retainer. Even if the frames are distributed over a wide area so they cannot regularly be checked by a human, the retainer can be relied upon to retain the container in the required orientation for the ovitrap to provide its function. The ovitraps can therefore be remotely managed by directed autonomous vehicles to travel to the mounted ovitraps, release the container by moving the retainer to the open position and lifting the container from the frame and replacing or emptying the container. The system for mounting an ovitrap therefore facilitates the autonomous management of distributed ovitraps by autonomous vehicles, although in some embodiments human operators may manage the ovitraps.

The components of the system will now be described in detail.

Container

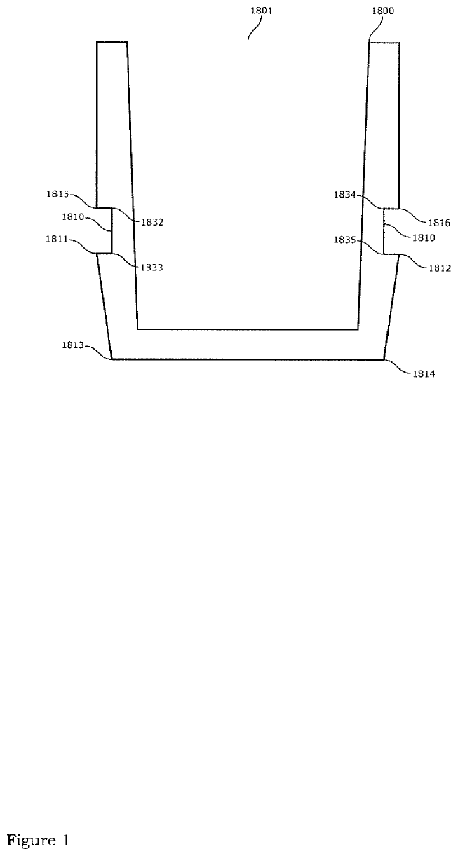

FIG. 1 illustrates a sectional side view of a container 1800 which can be used with the system of the present invention. The container 1800 has an opening 1801 on its top which 1800 is shaped so that insects of the targeted species can get access to the side walls of the container 1800 and to the surface of the liquid stored in it. The container 1800 comprises side walls and a base which together define an inner volume of the container 1800, the inner volume shaped so that it can hold a liquid like water for a predefined period of time. The container 1800 may have any cross-sectional shape but in the example of the figures the container has a substantially circular cross section so that the container is substantially cylindrical, closed at one end by the base.

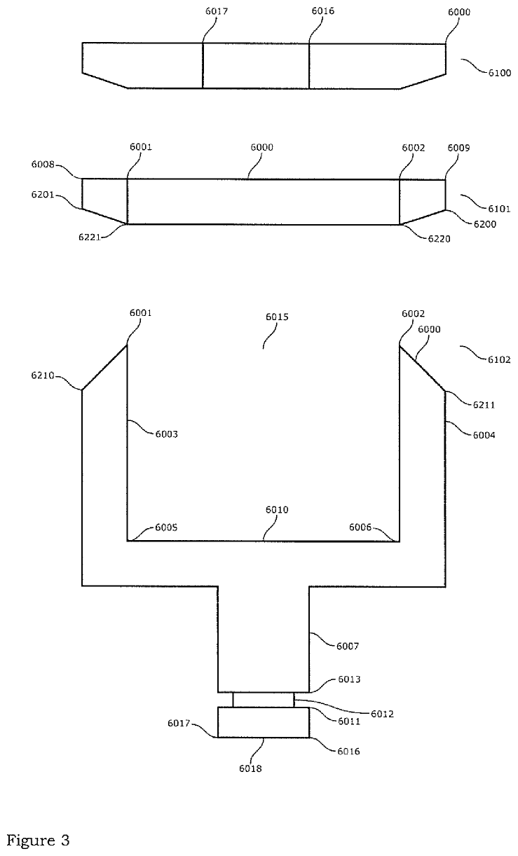

A groove 1810 on the outer side wall of the container 1800 is placed horizontally either all around the side walls of container 1800 or partially. The groove 1810 extends radially inwardly into the outer side walls of the container and provides two main functions: (1) to allow for gripping and lifting of the container by a holding tool, shown in FIG. 3, and (2) to provide means for a retainer 1, 2, 20, 21 to be used which engages with the groove 1810 in order to secure the container 1800 to the frame 2, as will be described in detail below.

In the particular, in the example of the figures, the groove 1810 is a circumferential groove running around the complete circumference of the container, which provides the advantage that the container does not have to be placed in a specific rotational orientation, as will be described.

The groove 1810 has an upper corner 1815 on the left side of the container 1800. The groove 1810 has an upper corner 1816 on the right side of the container 1800. The groove 1810 has a lower corner 1811 on the left side of the container 1800. The groove 1810 has a lower corner 1812 on the right side of the container 1800. The groove 1810 has an upper inner corner 1832 on the left side of the container 1800. The groove 1810 has a lower inner corner 1833 on the left side of the container 1800. The groove 1810 has an upper inner corner 1834 on the right side of the container 1800. The groove 1810 has a lower inner corner it the right side of the container 1800. The distance between the inner corner 1832 and the inner corner 1834 is less than the distance between the upper corner 1815 and the upper corner 1816. The distance between the inner corner 1833 and the inner corner 1835 is less than the distance between the lower corner 1811 and the lower corner 1812.

An important aspect is that the groove defines an upper surface (defined between points 1815 and 1832 and points 1816 and 1834 in FIG. 1) to which a force can be applied to lift the container 1800 and move it to a new location. Similarly the groove defines a lower surface (defined between points 1811 and 1833 and points 1812 and 1835 in FIG. 1) to which a force can be applied to restrict the upward movement of the container and therefore secure it in the frame.

The size of the groove 1810 has to be adjusted so that a tool 6000 used to lift the container 1800 fits into the groove 1810 and it is not damaged by moving the container 1800 and also the container 1800 is not damaged by the movement and by the tool used to hold the container 1800. The outer side walls of the container 1800 below the groove 1810 are slanted so that the distance between the lower corner 1811 at the bottom side of the groove 1810 on one side of the container 1800 and a lower corner 1812 at the bottom side of the groove 1810 on the other side of the container 1800 is larger than the distance of a corner 1813 at the bottom of the container 1800 and a lower corner 1814 at the other side of the bottom of the container 1800. The slanted outer side walls of the container are arranged to allow it to sit within correspondingly angled side walls of a frame as will be described below.

The distance between the corner 1811 and the corner 1813 is the same as the distance between the corner 1812 and the corner 1814 with some tolerance. The surface between the corner 1811 and the corner 1813 is even with some tolerance. The surface between the corner 1812 and the corner 1814 is even with some tolerance. The side wall below the groove 1810 can be used by a tool to the hold the container 1800 and/or to move it around. The surface of the outside bottom of the container 1800 between the corner 1813 and the corner 1814 is even with some tolerance. The container 1800 can be placed on any flat surface. Any number of grooves like the groove 1810 can be used on the side walls of the container 1800. The distance between the corner 1815 and the corner 1816 is close to the distance between the corner 1811 and the corner 1812.

The container 1800 can be made out of any material which does not repel mosquitoes. Possible materials include plastic, concrete and organic materials such as bio compostable material. In some examples, coconuts can be used to provide the container as they can be collected from waste product and shaped appropriately as the container 1800, ensuring that they do not leak. Advantageously, coconuts can be composted after use.

Frame for Holding the Container

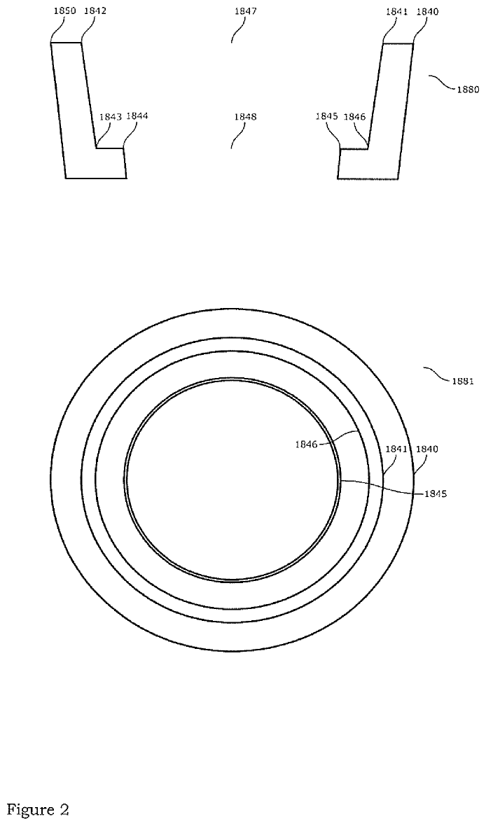

FIG. 2 illustrates a frame 1840 in a sectional side view 1880 and a view from top 1881. The frame 1840 provides the primary function of holding the container 1800 securely in an appropriate orientation so that it is not displaced or knocked over and the opening is exposed such that water-breeding insects can enter the container to deposit their eggs. The frame 1840 has an upper opening 1847 and a lower supporting surface, defined by the circumferential frame base between corners 1845 and 1846 and also the angled inner side walls of the frame, between points 1842 to 1843 and 1841 and 1846. The frame has side walls which define the upper opening and extend downwards to the lower supporting surface. In this way, a container 1800 can be inserted into the upper opening 1847 and lowered until it rests on the lower supporting surface. The container is therefore placed and removed in the frame by lowering and raising it through the upper opening.

In the embodiment of FIG. 2, the frame comprises inclined side walls which slope inwards from the upper opening to the lower supporting surface such that the cross-section of the frame reduces in size in a direction from the upper opening to the lower supporting surface. This makes it easier to place the container 1800 in the frame 1840 as the upper opening may be larger than the base of the container and allows the sloped inner side surfaces to support the container 1800 when placed within the frame 1840. The base surface may include a further opening as shown in FIG. 2. this can prevent water collecting in the frame which might allow for water-breeding insects to lay their eggs, reducing the efficacy of the ovitrap.

The shape of the frame 1840 when seen from top may have the same shape as the container it is supposed to hold. In the case of FIG. 2, the frame has a substantially annular side wall which defines the opening 1840 at the top and has an inner sloping surface meeting the lower supporting surface at the base of the frame. This makes this exemplary frame suitable for supporting the cylindrical container 1800 of FIG. 1.

In the specific case of when a coconut is used as the container 1800 to be held by the frame 1840, it is recommended to use a round shape. Any other shape can be used as long as both the frame 1840 and the coconut's bottom part fit together. The frame may be free standing such that it can rest on the floor or other surface at chosen locations. Alternatively, the frame may be fixedly attached to a surface or object, for example to the beams which provide clothing drying racks in HDB (Housing and Development Board) blocks, as will be described further below.

More specific relative dimensions of the frame of FIG. 2 are as follows. The frame 1840 is shaped so that the distance between an inner corner 1841 and an inner corner 1842 is larger than the distance between an inner corner 1843 and an inner corner 1846. The inner corner 1841 is above the inner corner 1846. The inner corner 1842 is above the inner corner 1843. The inner surface of the frame 1840 between the inner corner 1842 and the inner corner 1843 is even. The inner surface of the frame 1840 between the corner 1841 and the inner corner 1846 is even. The space between the inner corner 1841 and the inner corner 1842 form the opening 1847. The frame 1840 has a small step inwards starting at the inner corner 1843 and ending at the inner corner 1844. The frame 1840 has a small step inwards starting at the inner corner 1846 and ending at the inner corner 1844. The space between the inner corner 1844 and the inner corner 1845 form the opening 1848. The distance between the inner corner 1843 and the inner corner 1846 is larger than the distance between the inner corner 1844 and the inner corner 1845. The frame 1840 has an outer corner 1850. The outer corner is at the same level as the inner corner 1842.

The distance between the corners 1842 and 1843 is equal or less than the distance between the corners 1811 and 1813. The distance between the corners 1841 and 1846 is equal or less than the distance between the corners 1812 and 1814. In other words, the inside of the frame 1840 is shaped so that the container 1800 can be inserted so that the groove 1810 will stay above the frame's 1840 side walls even when the bottom of the container 1800 reaches the bottom of the frame 1840. The side walls of the frame 1840 will hold the container 1800 in position.

Holding Tool

FIG. 3 illustrates a holding tool 6000. A view 6100 shows the holding tool 6000 from its back. A view 6101 shows the holding tool 6000 from its front. A view 6102 shows the holding tool 6000 from its top. The holding tool 6000 can be used by a machine or a human tasked to move the container 1800. The holding tool 6000 can be manufacturing out of metal, wood, fibre reinforced concrete or fibre reinforced plastic.

The holding tool includes two holding arms 6003, 6004 which are arranged such that they can be brought into engagement with the groove of a container. In particular, the arms are substantially parallel and appropriately spaced by opening 6015 such that they will pass either side of the side walls of a container when brought towards a container, sliding into the grooves on either side of the container. By moving the holding tool upwards once the arms are engaged with the groove of a container, the holding tool can be used to exert a force on the downward facing (upper) surface of the groove in order to lift a container. In particular the holding tool can be used to lift the container out of the frame to move or replace the container. The holding tool can also provide the function of moving the one or more retainers to the open position to allow the container to be lifted. More specifically the holding tool provides means to both release the retainer and engage with the groove of the container simultaneously. As will be described in more detail below the arms of the holding tool can have angled ends which are arranged to progressively displace the retainer as the arms engage with the groove of a container when it is held by a frame.

The holding tool preferably has a substantially U-shaped structure with two substantially parallel holding arms connected by an adjoining beam such that they are appropriately spaced to engage with the groove either side of the container. The adjoining beam which connects the arms is also connected to a handle 6007 which can be used to hold the tool by wither a human or autonomous vehicle.

The specific relative dimensions of the specific embodiment are described as follows. The holding tool 6000 has a holding arm 6003 and a holding arm 6004. The holding arm 6003 and the holding arm 6004 are connected with a beam 6010. The side of the holding arms 6003 and 6004 not connected with the beam 6010 form an opening 6015. The holding arm 6003 has a corner 6001 on its tip opposite of the holding arm 6004. The holding arm 6004 has a corner 6002 opposite the holding arm 6003. The distance between the corner 6001 and the corner 6003 defines the dimension of the opening 6015. The holding arm 6003 and the beam 6010 form an inner corner 6005. The holding arm 6004 and the beam 6010 form the inner corner 6006. The distance between the inner corner 6005 and the inner corner 6006 can be smaller than the distance between the corner 6001 and the corner 6002 but it has to be considered that the container 1800 has to move into the opening 6015 deep enough so that the container 1800 will not leave the holding tool 6000 when the holding tool 6000 is being moved. The holding arm 6003 has a corner 6210. The corner 6210 is on the other side of the holding arm 6003 located away from the opening 6015. The corner 6211 is on the other side of the holding arm 6004 located away from the opening 6015. The holding arm 6004 has a corner 6211.

When seen from top, the corner 6001 has an inside angle of less than 90 degrees. When seen from top, the corner 6002 has an inside angle of less than 90 degrees. When seen from top, the corner 6210 has an inside angle of more than 90 degrees. When seen from top, the corner 6211 has an inside angle of more than 90 degrees. The holding arm 6003 and the beam 6010 form a L-shaped structure when seen from top. The holding arm 6004 and the beam 6010 form a mirrored L-shaped structure when seen from top.

Together, the holding arm 6003, the holding arm 6004 and the beam 6010 form a U-shaped structure when seen from top. The distance between the corner 6001 and the corner 6002 has to be larger than the distance between the corner 1832 and the corner 1834 but smaller than the distance between the corner 1815 and the corner 1816. The beam 6010 connects to a handle 6007 on the other side of the holding arms 6003 and 6004. The holding tool 6000 can be attached to a machine via the handle 6007. The handle 6007 has a corner 6016 on one side of its end 6018 away from the beam 6010. The handle 6007 has a corner 6017 on the other side of its end 6018. A groove 6012 is located near to the end 6016 of the handle 6007 away from the beam 6010. The groove has a corner 6011 closer to the end 6016 and a groove 6013 farther away from the end 6016. The groove 6012 can be used by a machine to hold the holding tool 6000 while applying forces to all directions.

The view 6001 shows the holding tool 6000 when seen from its front. The corners 6001 and 6002 are shown for reference in the middle figure. When seen from its front, the holding tool 6000 has a corner 6008 on its top left side. When seen from its front, the holding tool 6000 has a corner 6009 on the top right side. The corner 6008 and the corner 6009 can be connected by a straight line. When seen from front, the holding tool 6000 has a corner 6201 on its bottom left side. Then seen from front, the holding tool 6000 has a corner 6200 on its bottom right side. The corner 6201 is the left outside corner of the holding arm 6003. The corner 6200 is the right outside corner of the holding arm 6004. When seen from front, the holding arm 6003 has a corner 6221 on its inside bottom. When seen from front, the holding arm 6004 has a corner 6220 on its inside bottom. The corner 6001 is located just above the corner 6221. The corner 6002 is located just above the corner 6220. The distance between the corner 6008 and the corner 6201 is smaller than the distance between the corner 6001 and the corner 6221. The distance between the corner 6009 and the corner 6200 is smaller than the distance between the corner 6002 and the corner 6220. The distance between the corner 6001 and the corner 6221 has to be adjusted so that the holding tool 6000 can be inserted into the groove 1810 of the container 1800 from the side of the container 1800. The corners 6016 and 6017 are shown for reference in the view 6100.

The handle 6007 when seen from the back has a rectangle like shape. Alternatively, any other shape can be used which makes sure that the handle will not rotate when forces are applied to the holding tool 6000 while it is held by a machine. This shape allows the machine to pick the tool 6000 up easily and it will make sure that the holding tool 6000 will not rotate itself when held by the machine. The holding arms 6003 and 6004 can be attached so to the beam 6010 that the machine using the holding tool 6000 is able to change the dimension of the opening 6015 while operating the holding tool 6000. The dynamic adjustment of the dimension of the opening 6015 allows the machine operating the holding tool 6000 to adjust the dimension of the opening 6015 to the size of the container 1800. The arm 6010 can connect the holding arm 6003 with the holding arm 6004 in a straight line or in a curved line. Preferably, the contour of the line connecting the inner corner 6005 with the inner corner 6006 follows the contour of the container 1800 when seen from the top.

Alternatively, a set of holding tools can be provided with different holding tools 6000 have a different distance between the corner 6001 and the corner 6002. When the container 1800 is placed on a floor or on within the frame, the holding tool 6000 should be able to move out of the groove 1810 without moving the container 1800 when the holding tool 6000 is moved so that the beam 6010 moves away from the container 1800. The holding tool can either be used by a human operator or a vehicle used to handle one or more containers 1800.

First Embodiment: Retainer Provided by a Clip

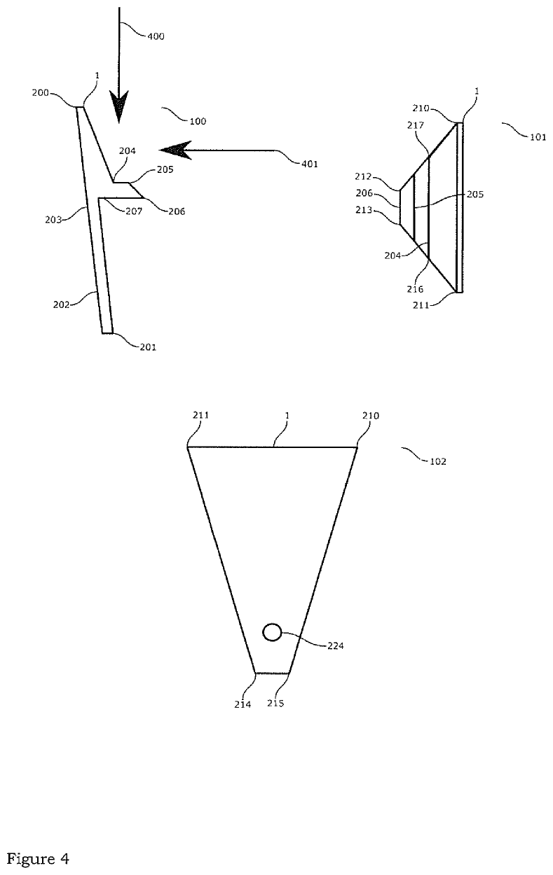

FIG. 4 illustrates retainer according to the present invention. In this embodiment the retainer is provided by a clip 1. A view 100 shows the clip 1 from its side. A view 101 shows the clip 1 from its top. A view 102 shows the clip 1 from its back.

As shown in the side view 100, the clip has an elongate body extending from a base 201 upwards to a top surface 200. The clip 1 includes a protrusion (or “nose”) defined by the points 204, 205, 206, 207 which extends outwards from the body and is configured to engage with the groove of the container, as will be described. The protrusion extends out of the plane of the body, in a roughly perpendicular orientation. The body may have an attachment 224 near the base which is configured to attach to an outer side wall near of the frame, near the base of the frame, with the body shaped so as to substantially follow the outer surface of the frame. The protrusion is at a certain height along the body of the clip from the base so as to extend over the top surface of the frame so that the protrusion can reach into the groove of the container when the container is held in the frame with the clip attached. The body of the retaining clip is flexible so that when the base of the body is attached with attachment 224 a force in the direction 401 acts to elastically deform the body so that it bends outwards and the protrusion is retracted. The clip preferably has an angled upper surface so that a downward force 400 on the upper surface also results in an outward movement of the clip when attached. In this way, as will be described, lowering the container into the upper surface of the clip causes it to bend into a retracted position allowing the container to be received by the frame.

The form of the specific clip of FIG. 4 will now be described in more detail. The clip 1 looks in the view 100 like a flat sheet with a nose on one side. The clip 1 has an upper end 200. The clip 1 has a bottom end 201. The clip 1 is divided into three section between the upper end 200 and the lower end 201. The bottom section starts at the bottom end 201 and ends at the location 202. The middle section starts at the location 202 and ends at the location 203. The section between the location 202 and the location 203 is flexible. This will allow that the upper end 200 will move left or right relative to the bottom end 201 when the bottom end 201 is fixated and a force from left or right is applied to the upper end 200. When no force is applied, the upper end 200 will return into its natural position. One side of the clip 1 as seen in the view 100 is flat. The other side of the clip 1 as seen in the view 100 has a nose defined by a corner 204, a corner 205, a corner 206 and a corner 207. The angle of the corner can be larger than 90 degrees. The angle of the corner 205 can be less than 270 degrees. The angle of the corner 206 can be larger than 270 degrees. the angle of the corner 207 can be smaller than 90 degrees. The distance between the corners 206 and 207 has to be larger than the distance between the corner 1842 and the corner 1850 plus an extra which is smaller than the distance between the corner 1833 and the corner 1811. The top view 101 show a left corner 210 located at the left side of the upper end 200 of the clip 1. The top view 101 shows a right corner 211 located at the right side of the upper end 200 of the clip 1. The top view 101 shows a left corner 212 located at the left side of the corner 206. The top view 101 shows a right corner 213 located at the right side of the corner 206. The corner 204 meets at a location 217 the connection between the corner 210 and a corner 215. The corner 215 is located at the left side of the bottom end 201. The corner meets at a location 217 the connection between the corner 211 and a corner 214. The corner 214 is located at the right side of the bottom end 201. The distance between the location 216 and the location 217 is larger then the distance between the corner 212 and the corner 213.

The clip 1 as seen in the view 101 is symmetrical top to bottom as shown in the drawing. The view 102 shows an opening 224 near the corners 214 and 215. The opening can be used to attach the clip 1 to the frame 1840. An arrow 400 indicates a direction from the top of the clip 1 towards the bottom end of the clip 1. An arrow 401 indicates a direction onto the clip 1 of the side of the corner 204. The upper end 200 is farther to the left than the corner 204. As such, the section between the upper 200 and the corner 204 is a slope. When a force with the direction as indicated by the arrow 400 hits the section between the upper end 200 and the corner 204, the upper end 200 will move into the direction as indicated by the arrow 401. When the lower 201 of the clip 1 is held into position, the clip 1 will bend between the locations 202 and 203 into the direction as indicated by the arrow 401.

Securing the Container to the Frame

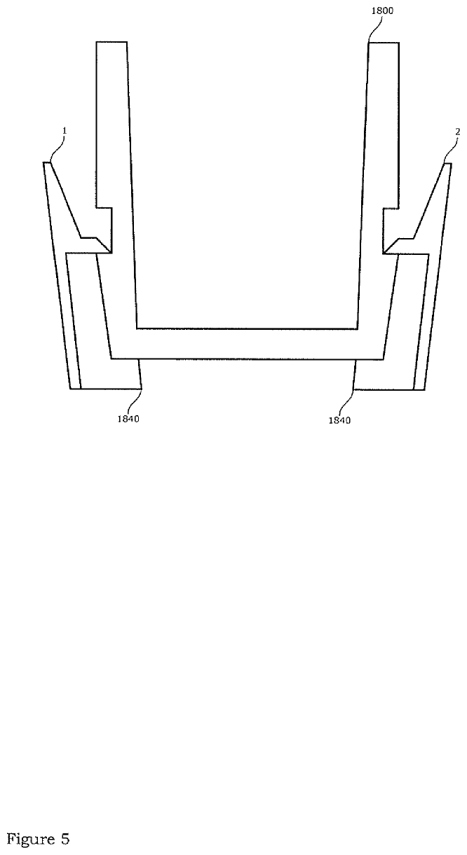

FIG. 5 illustrates an assembly of the container 1800, the frame 1840, and two clips provided on opposing sides of the frame. As described above, the frame comprises a substantially annular side wall defining an upper opening with inwardly sloping inner surfaces which meet the supporting surface on which the container sits. The container is therefore placed through the upper opening into the received position as shown in FIG. 5. In this example two retainers are provided in the form of two clips 1, 2 each as described above. The attachment at a lower end of the flexible body is used to attach a bottom end of the retainer to the outer surface of the frame near the base. In this arrangement, each retaining clip lies against the outer side walls of the frame with the protrusion lying against the upper rim around the opening to the frame and extending over the side wall of the frame into the circumferential groove of the container.

As a lower surface of the protrusion lies against the upward facing lower surface of the groove, the container cannot be lifted upwards out of the frame as the container between the retainer and groove limits upwards movement of the container. The container is therefore restrained between the contact between the base of the container and the lower supporting surface of the frame and the contact between the protrusion of the retainer and the groove. The clip 1 on the left side and a clip 2 on the right side in a sectional side view. The clip 2 is a copy of clip 1. The container 1800 is inserted into the frame 1840 in a sectional side view. The clips 1 and 2 hold the container in position. Two clips are used for demonstration purpose. Any number of clips can be used to hold the container 1800 into position.

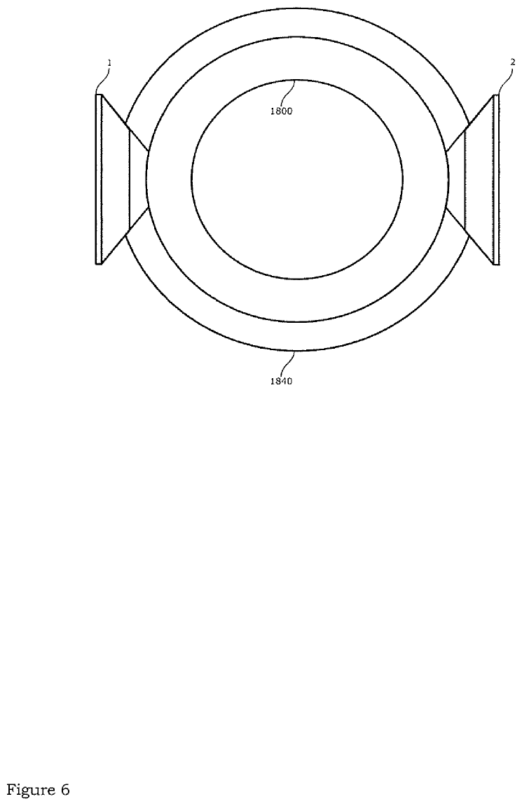

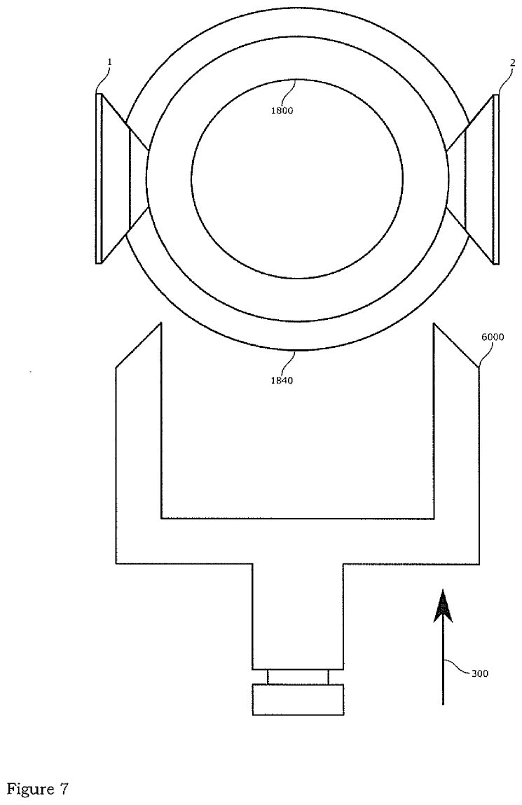

FIG. 6 illustrates the same assembly as in FIG. 5 but as seen from top. The container 1800, the frame 1840, the clip 1 on the left side and the clip 2 on the right side from top. As illustrated the clips may have a substantially triangular cross section when seen from above. FIG. 7 illustrates how the tool 6000 is used to extract the container 1800 from the frame 1840 as seen from the top. An arrow 300 indicates the direction of the tool 6000. The frame 1840 and the container 1800 do not move. The frame 1840 is attached to a structure not allowing the frame 1840 to move. The tool 6000 is adjusted so that the container 1800 is in the middle of the holding arms 6003 and 6003.

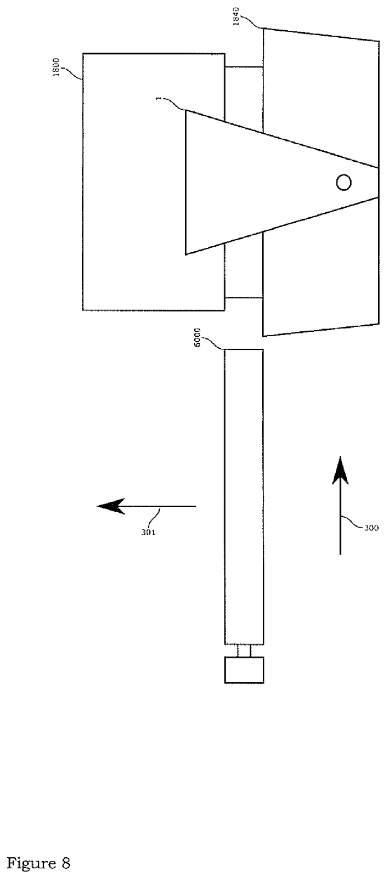

FIG. 8 illustrates the same situation as FIG. 7 but as seen from the side. An arrow 301 indicates a second direction away from the frame 1840. The tool 6000 is moved into the direction as indicated by the arrow 300. The level of the tool 6000 is aligned so that it is the same as the level as the groove 1810. The horizontal orientation of the tool 6000 is aligned so that the container 1800 is located between the holding arm 6003 and the holding arm 6004. The holding arms 6003 and 6004 will first move into the groove 1810 and later meet the sides of the clips 1 and 2. All meeting surfaces are arranged in an angle so that they will start gliding and only the upper ends 200 of the clips 1 and 2 are not forced to stay in position, the upper ends 200 of clips 1 and 2 will move away from the container 1800 and free with this move the container 1800. When the clips 1 and 2 freed the container 1800, the movement of the tool 6000 into the direction as indicated by the arrow 300 will be stopped. The tool 6000 will then be moved into the direction as indicated by the arrow 301. This will move the container 1800 out of the frame 1840. The clips 1 and 2 will also bend back into their original position.

As illustrated in FIGS. 7 and 8 the tool 6000 is advanced towards the mounted container in direction 300 so that the arms pass either side of the body of the container and enter the circumferential groove. As most clearly seen in FIG. 7, as the arms of the tool are brought into the groove, the angled leading edges of the arms will meet the clips. Returning to FIG. 5, it can be seen that the protrusion when in the groove, leaves space within the groove for the arms of the tool to enter. As the ends of the arms enter these spaces above the protrusion, the angled ends of the tool arms meet the upper angled surfaces of the clip such that as the tool is advanced the retaining clip is bent outwards about the attachment point, retracting the protrusion from the groove. Therefore, when the arms are fully inserted the outer surface of the arms holds the clip in the open position allowing the holding tool to be lifted upwards and away from the frame to remove the container in direction 301, shown in FIG. 8.

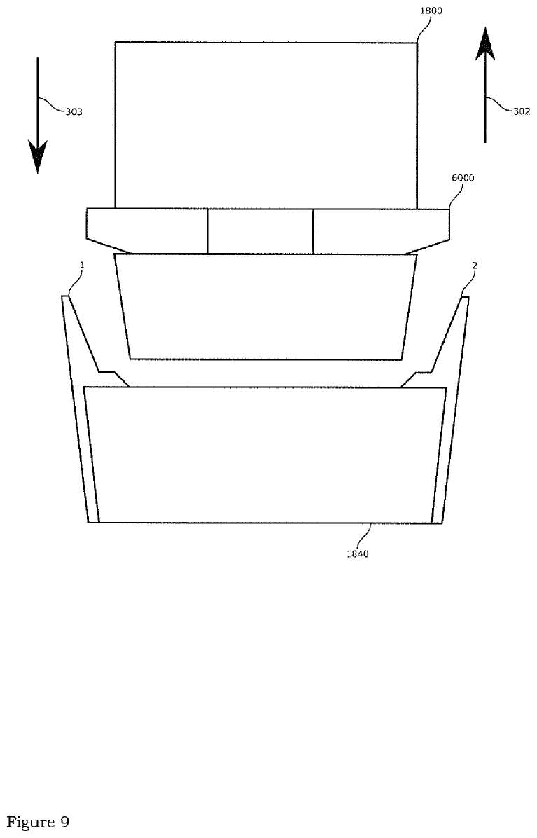

FIG. 9 illustrates a side view of the container being raised out of the frame using the tool 6000. As the body of the clips 1, 2 is elastic, once the container is lifted out of the way the clips spring back to their biased position in which the protrusions extend over the top of the side wall of the frame, radially inward. FIG. 9 shows the clips 1 and 2 are in their resting position. An arrow 302 indicates the direction the container 1800 is moved away from the frame 1840. An arrow 303 indicates the direction the container 1800 is moved into the frame 1840. The distance of the upper end 200 of the clip 1 and the upper end 200 of the clip 2 has to be larger than the distance between the corner 6210 and the corner 6211. The distance between the corner 206 of the clip 1 and the corner 206 of the clip 2 has to be larger than the distance between the corner 1813 and the corner 1814. The distance between the corner 206 of the clip 1 and the corner 206 of the clip 2 has to smaller than the distance between the corner 1811 and the corner 1812 but less than the distance between the corner 1833 and the corner 1835. The surface between the upper end 200 of the clip 1 and the corner 204 of the clip has to be arranged so that the tool 6000 can move the upper end 200 of the clip 1 away from the container 1800.

Similarly, as the container is lowered back into the frame in direction 303 the angled upper surface of the protrusion and upper portion of the clip body is such that as the base of the container meets the clip, continued downward movement into the clip increasingly displaces the clip in an outward direction to allow the container to be positioned in the retained position in the frame, as soon as the tool is retracted the clips will return to their biased position in which the protrusions extend into the groove retaining the container in the frame.

More specifically, the surface between the corner 205 and the corner 206 is designed so that the container can move the upper end 200 of the clip 1 away from the container 1800. To position a container 1800 in the frame 1840, the tool 6000 holding the container 1800 is first moved into a position just above the centre of the frame 1840, as shown in FIG. 9. The tool 6000 holding the container 1800 is then moved downward into the opening of the frame in the direction as indicated by the arrow 303. When the tool 6000 meets the clip 1 or the clip 2 between the upper end 200 and the corner 204, the upper ends 200 of the clips 1 and 2 will start to move in an outward direction, i.e. to the outside of the frame 1840. As result, the container 1800 can be moved into its resting position inside the frame 1840. The tool 6000 will then be moved into the opposite direction as indicated by the arrow 300. When the tool loses the contact with the clips 1 and 2, the upper ends 200 of the clips 1 and 2 will move into their natural position and as such lock the container 1800 inside the frame 1840.

Second Embodiment: Retainer Provided by a Latch

In alternative example of the present invention, the retainer may be provided by a latch rather than a clip. This is based on exactly the same principle of providing a protrusion which can be selectively extended into the groove of a container held in the frame in order to lock the container to the frame and can equally be withdrawn, as with the clip, in order to release the container from the frame. The primary difference is that the movement of the protrusion between the extended, locked position and the retracted, open position is provided by means of an actuator 2000 rather than just by providing a force against the retainer, for example with the tool.

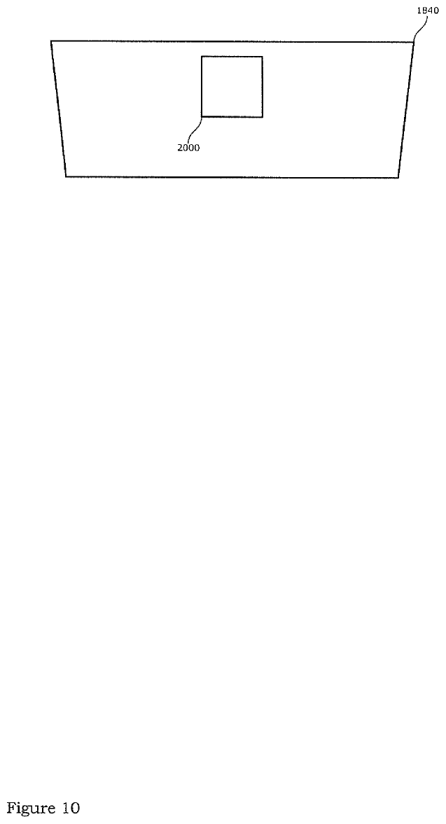

FIG. 10 illustrates the frame 1840 and an actuator 2000 positioned on a frame in a side view. The actuator 2000 is connected to a latch comprising protrusions 20, 21 which are arranged to extend into the circumferential groove in the container when the actuator is actuated. The actuator may take the form of a button or switch which is activated by contact by a human operator or autonomous vehicle, alternatively it may be a connector to which data or signal may be sent in order to selectively open or close the latch. For example the connector may connect physically with a corresponding connector on an autonomous vehicle or wirelessly in order for instructions to be sent to open or close the latch.

In this example, the connector 2000 is used to connect a vehicle to the frame 1840. The connector 2000 is a mechanical connection able to transfer forces into all three axis and torque left and right and/or a electrical connection able to transfer electrical signals.

When a vehicle arrives at the frame 1840 it connects via the connection 2000 with the frame 1840. The connection 2000 will then transfer the forces between the frame 1840 and the vehicle when the vehicle uses the tool 6000 to extract a container 1800 from the frame 1840 or inserts the container 1800 into the frame 1840.

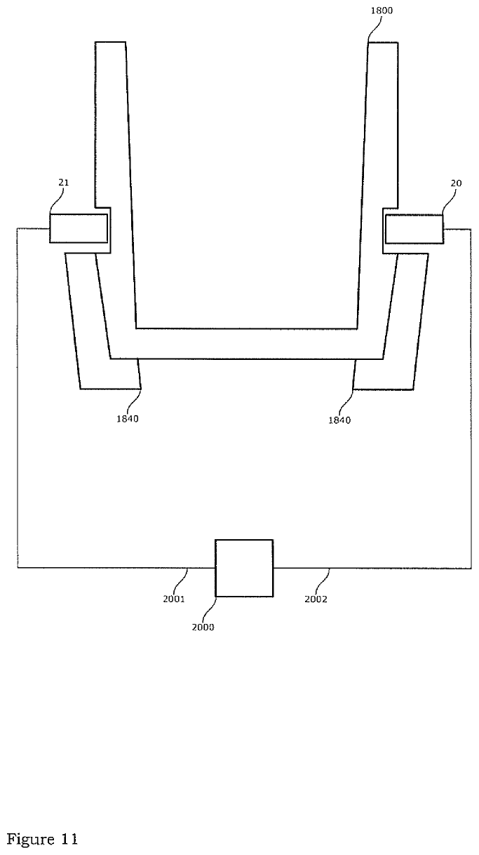

FIG. 11 illustrates the frame 1840 with the container 1800 inserted into the frame 1840 in a sectional side view. A latch 20 is installed at the frame 1840 so that it is able to move into the groove 1810 when the container 1800 is inserted into the frame 1840. A latch 21 is installed at the frame 1840 so that it is able to move into the groove 1810 when the container 1800 is inserted into the frame 1840. When the latch 20 is moved into the groove 1810 towards the container 1800, the latch 20 does not allow the container 1800 to be moved out of the frame 1840. When the latch 21 is moved into the groove 1810 towards the container 1800, the latch 21 does not allow the container 1800 to be moved out of the frame 1840. One latch 20 or more latches can be installed at the frame 1840. The latch 20 is connected via the connection 2002 with the connector 2000. The latch 21 is connected via the connection 2001 with the connector 2000. The latch 20 communicates via the connection 2002 with a vehicle connected to the frame 1840 via the connector 2000. The latch 21 communicates via the connection 2001 with a vehicle connected to the frame 1840 via the connector 2000. The commands which can be send to the latches 20 and 21 are a status request, to open and to close. To open means that the latches 20 and 21 are moved out of the groove 1810 so that the container 1800 can freely be moved in or out of the frame 184-. To open means that the latches 20 and 21 are moved into the groove 1810 so that the container 1800 which is currently inserted into the frame 1840 will not be able to be moved out of the frame 1840. The status request will tell the vehicle connected via the connector 2000 if the latch 20 or 21 is in the open position allowing the container 1800 to be freely in and out of the frame 1840 or in the closed position holding a container 1800 inserted into the frame 1840 in its location.

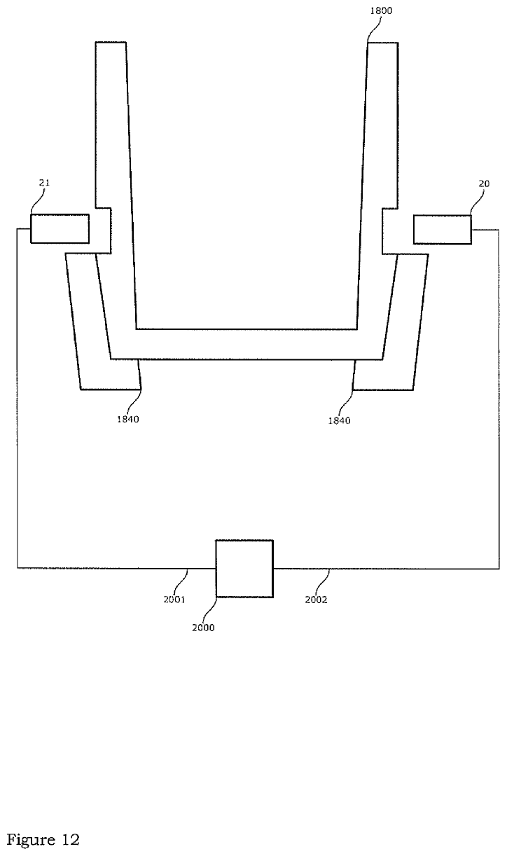

FIG. 12 illustrates the frame 1840 with the container 1800 inserted into the frame 1840 in a sectional side view. The latch 20 is in its open position being moved out of the groove 1810. The latch 21 is in its open position being moved out of the groove 1810. The container 1800 can be freely moved in and out of the frame 1840 when the latches 20 and 21 are in this position.

Protective Container for the Ovitrap

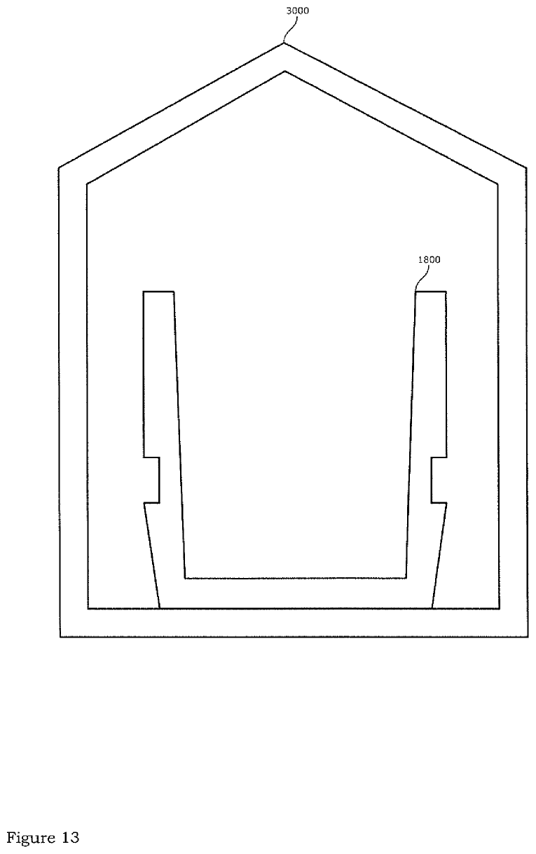

The ovitrap may be provided within a protective container which can further prevent the ovitrap from being knocked or spilled it can further only permit insects of a certain size to enter. In the following illustrative examples the protective container takes the form of a “house”. FIG. 13 illustrates in a sectional drawing the container 1800 sitting on a floor of a house 3000. The house has a roof, walls and a floor just like any other house. The size of the house 3000 is adjusted so that there is some empty space above the container 1800 between the roof of the house 3000 and the container 1800 and a gap left and right of the container 1800 between the left wall of the house 3000 and the left side of the container 1800 and the right wall of the house 3000 and the right side of the container 1800 so that the container 1800 can be moved in and out of the house with the help of the tool 6000. The container 1800 sits on the floor of the house 3000.

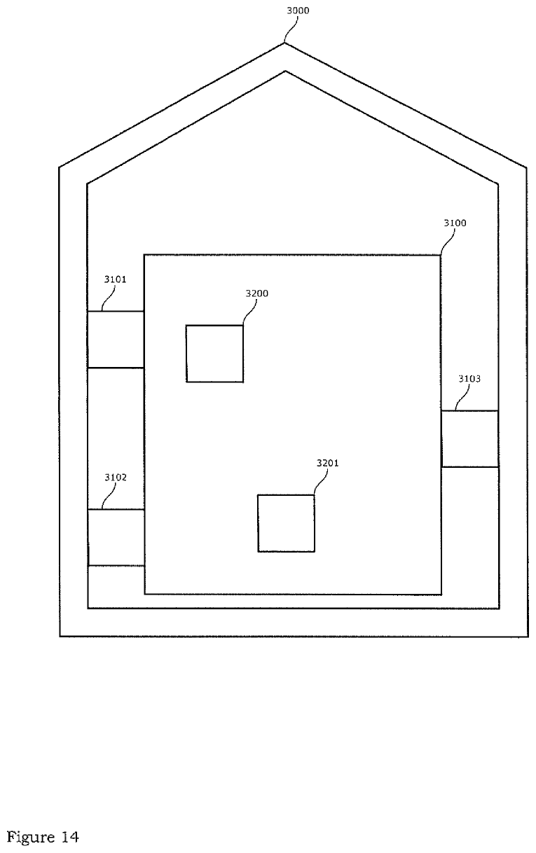

FIG. 14 illustrates the house 3000 in a side view. The house 3000 has a door 3100 attached to it by a hinge 3101, a hinge 3102 and a lock 3103. The door 3100 has an opening 3200. The door 3100 has an opening 3201. The hinges 3101 and 3202 hold the door 3100 in place but allow the opening of the door when a lock 3103 does not block the opening. The gaps between the door 3100 and the house 3000 have to be at least the size so that the targeted insects are able to enter the house 3000 but small enough to not allow the access of other creatures to the container 1800 inside of the house 3000. One or more openings 3200, 3201 in the door have to be large enough to allow the access of the targeted insect species to the container 1800 inside the house 3000 but small enough to block the access to the container 1800 by larger creatures.

The frame 1840 has to be attached to an object so that it cannot be moved away. The house 3000 has to be attached to an object so that it cannot be moved away. One or more latches 20, 21 can used to hold the container 1800 into position inside the frame 1840.

Mounting the ovitrap in an elevated position

It can be advantageous in certain situations to mount the ovitrap frame and container in an elevated position. This can help avoid problems with the ovitraps being dislodged or knocked over by humans and means they can be placed in locations where they do no obstruct humans. An important possibility is to utilise beams already present on buildings for example, drain pipes, overflow pipes, aerials, satellite dishes and importantly beams present in HDB blocks prevalent in Singapore. In particular the frame, as described above can be mounted to the beams to provide the ovitraps in an elevated position, out of the way of occupants of the building but in close proximity to areas heavily populated by humans where it would be desirable to reduce insect populations. Equally the frame can be configured to mount directly to a surface such as a wall or roof by means of appropriate attachment means.

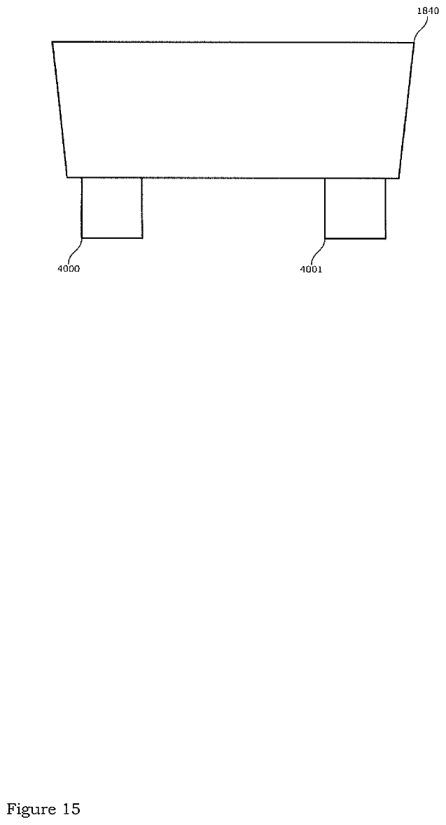

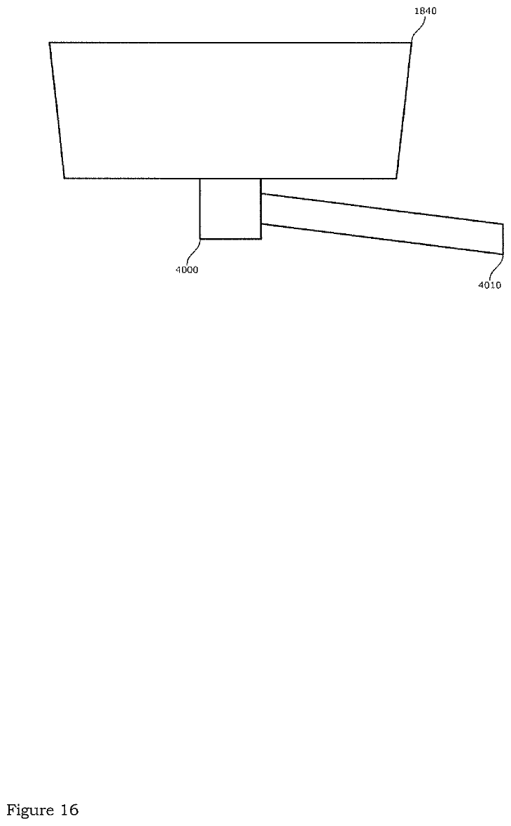

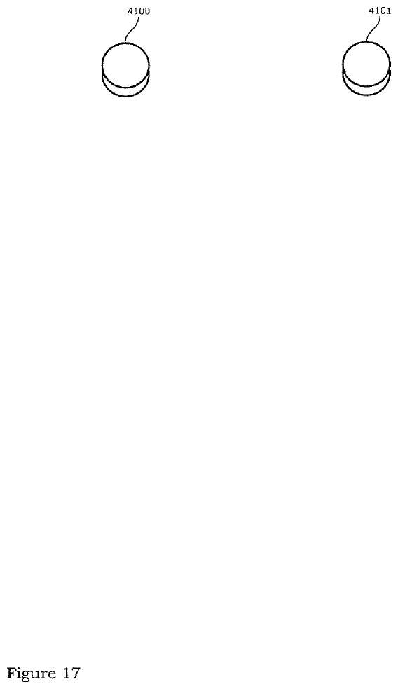

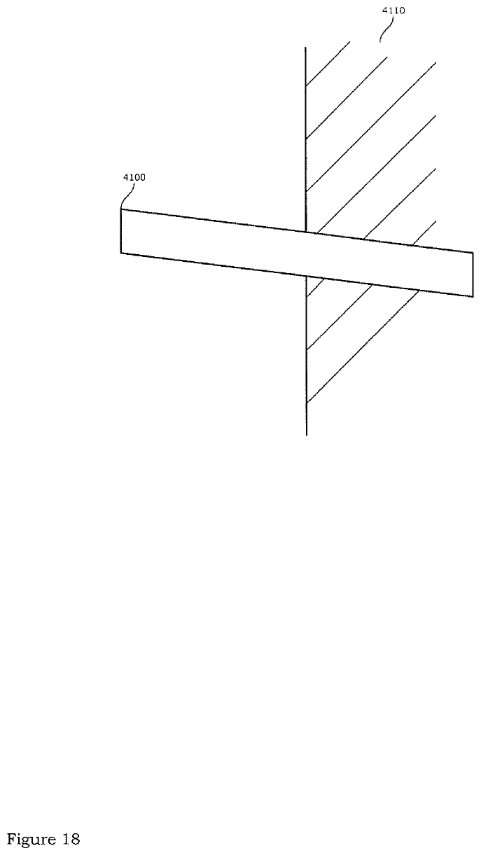

FIG. 15 illustrates the frame 1840 with a holder 4000 attached to its bottom in a front view. The frame 1840 has a holder 4001 attached to its bottom. FIG. 16 illustrates the frame 1840 with the holder 4000 in a side view. A tube 4010 is attached to the holder 4000 so that it stands out on one side of the holder 4000. FIG. 17 illustrates a tube 4100 and a tube 4101 in a front view. FIG. 18 illustrates the tube 4100 in a side view installed in a wall 4110. The tube 4100 is installed so that the end outside of the wall 4110 is located higher than the end inside the wall 4110.

The tube 4100 may be provided by for example an overflow pipe in from a building or beam often used for drying clothes in a housing development block in Singapore. The ovitraps are mounted as described above apart from the connection (holder) 4000 is arranged to attach to the base of the frame and has an extension 4010 that can attach to a beam. In this way the ovitraps can be mounted in elevate positions and be tended by autonomous flying vehicles which can release the retainer (the clip or latch) as described above in order to replace the container.

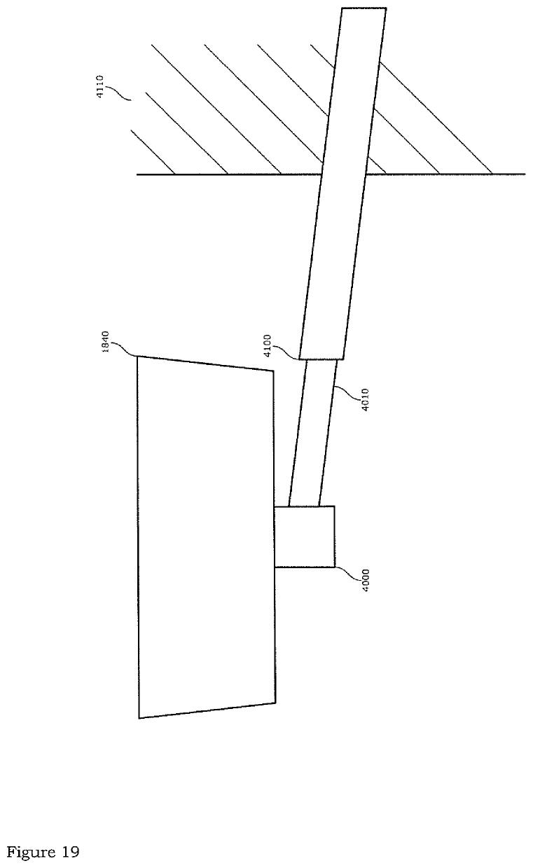

FIG. 19 illustrates the assembly of the socket 1840, the holder 4000, the tube 4010, the tube 4100 and the wall 4110 in a side view. The tubes 4010 and 4100 are slid over each other so that the tube 4010 becomes an extension of the tube 4100.

The tube 4100 is held by the object, e.g. a wall, it is installed in. The tube 4010 is held by the tube 4100 in position. The tube 4010 hold the connector 4000 in position. The connector 4000 holds the frame 1840 into position. Alternatively, the frame 1840 can be replaced by the house 3000. Alternatively, the wall 4110 can be replaced by any other object to hold the tube 4100. Especially for tree breeding insects, the tube 4100 can be installed in a tree.

In other examples the connector 4000 can be configured to mount directly to a surface rather than be connected to a tube 4100. For example in the case of newer style washing line structures provided in HDB blocks in Singapore a protruding structure is provided which is attached to the wall of a building on which multiple rails may be mounted on which, for example, clothes may be hung. The connector 4000 may be provided to mount directly to this structure or to the rails so as to connect to any such clothing drying structure or any protruding structure from a building, allowing the ovitraps to be mounted in elevates positions.

Operation of a System of Ovitraps

A network of containers 1800 is placed in an area. The containers 1800 placed at a floor are preferably placed in an secured frame 1840 or in an secured house 3000. The containers 1800 placed above ground level are preferably installed using the holders 4000, the tubes 4010 and the tubes 4100 at walls 4110 at any level the targeted insect species can reach. This allows the creation of a three dimensional network of containers place at any level the targeted insect species might reach. When walls are not available, poles can be erected to serve as a holder for the tube 4100 or even trees can be used as natural holders for the tubes 4100. The containers 1800 attached to wall 4110 via the tubes 4010 and 4100 are serviced by autonomous vehicles with the ability to fly. The containers 1800 placed at a floor can either be serviced by autonomous vehicles able to move on land or by autonomous vehicles with the ability to fly. The containers 1800 have to be placed so that both the targeted insect species are able to access them and the vehicle used to service the containers 1800 are able to access the containers 1800 and also operate around the individual containers 1800.

By using the holders 4000, the tubes 4010 and the tubes 4100, the containers 1800 can be installed in locations normally not accessible for human operators. Many of the targeted insect species avoid breeding in the presence of humans. Operating the containers 1800 in such locations by autonomous vehicles allows the collection of eggs from the targeted insect species with an efficacy not seen in locations with human presence.

1. A system for mounting an ovitrap, the system comprising:
a frame arranged to hold a removable container within the frame,
a retainer configured to secure the container within the frame, wherein the retainer is configured to move between:
a closed position, in which the retainer extends towards and grips the container when the container is in the frame; and
an open position, in which the retainer is withdrawn from the container, allowing the container to be removed from the frame;
wherein the frame comprises:
an upper opening arranged to receive the container; and
a substantially annular side wall defining the upper opening, with sloping internal side walls such that the internal cross section of the frame decreases with distance from the upper opening, the sloping inner side walls configured to support the container when replaced in the frame.

2. The system of claim 1 further comprising:
a container arranged to hold a liquid and collect the eggs of a water-breeding insect, the container comprising a groove extending at least partially around an outer side wall of the container; wherein:
in the closed position, the retainer extends into the groove of the container to prevent a container from being removed from the frame; and
in the open position, the retainer is withdrawn from the groove of the container, allowing a container held in the frame to be removed.

3. The system of claim 2, wherein the groove is a circumferential groove running around the circumference of the outer side wall of the container.

4. The system of claim 2 wherein, in the closed position, the container is secured between the frame and the contact between the retainer and the groove.

5. The system of claim 2 wherein the groove is positioned at a sufficient height on the side wall of the container such that the groove is exposed above the frame when the container is held in the frame.

6. The system of claim 2 wherein the retainer comprises:
a protrusion arranged to extend into the groove of the container when the retainer is in the closed position; and
an elastic body configured to bend when an outward force is applied to move the protrusion out of the groove into the open position, the elastic body biased to return to the closed position when the force is removed.

7. The system of claim 6 wherein:
the body of the retainer comprises an attachment arranged to secure the retainer to an outer surface of the frame near the base of the frame, the elastic retainer body extending upwards from the base of the frame along an outer surface of the frame; and
the protrusion is arranged such that it extends over the frame to engage with the groove when a container is held in the frame; wherein
the retainer body is arranged to bend away from the container from the closed position to the open position.

8. The system of claim 4 wherein the container comprises a groove on two opposing outer sides and the system comprises two retainers, each arranged to engage with the groove on an opposing outer side of the container, the system further comprising:
a holding tool comprising two arms arranged to pass either side of the container to enter the grooves on the opposing sides of the container such that the container can be lifted out of the frame via the engagement of the arms of the holding tool with the grooves of the container; wherein
the system is arranged such that when the tool is moved into engagement with the grooves, the arms of the tool are brought into contact with the retainers to apply an outward force to the retainers to move them into the open position.

9. The system of claim 8 wherein the protrusion of the retainer occupies only a portion of the total height of the groove when in the closed position, thereby leaving a gap configured such that the arms of the holding tool can enter the grooves alongside the protrusions.

10. The system of claim 8 wherein the arms of the holding tool each comprise an angled end arranged to meet the retainer when the holding tool is moved into the grooves of the container within the frame, the angled ends arranged to increasingly displace the retainers as the arms of the holding tool are advanced into the grooves to progressively bend the retainers into the open position.

11. The system of claim 6 wherein the protrusion has an angled upper surface arranged such that the container or the holding tool meets the angled surface as the container is lowered into the upper opening of the frame, the angled upper surface arranged such that continued movement of the container into the frame increasingly displaces the retainer to move the retainer into the open position such that the container can be received within the frame.

12. The system of claim 1 further comprising an actuator, wherein the retainer is configured to move between the closed and open position upon actuation of the actuator.

13. The system of claim 12 wherein actuator is a button or switch configured to move the retainer between the closed and open position upon contact with the button or switch.

14. The system of claim 12 wherein the actuator has a connector to which a connection may be established to provide instruction to move the protrusions between the closed and open positions.

15. The system of claim 14 wherein the connector is configured to connect via contact or via wireless connection with a corresponding connection on an autonomous vehicle; wherein the connection is configured to receive instructions from the autonomous vehicle to move the protrusions between the closed and open positions.

16. The system of claim 12 wherein the actuator is arranged to be actuated by an autonomous vehicle or a human operator.

17. The system of claim 1 further comprising an autonomous vehicle configured to grip and move the container such that the container can be replaced by the autonomous vehicle.

18. The system of claim 17 further comprising a holding tool comprising two arms arranged to pass either side of the container to enter the grooves on the opposing sides of the container; wherein the autonomous vehicle is configured to use the holding tool to replace the container.

19. The system of claim 1 wherein the frame is configured to fixedly attach to a beam to allow the ovitrap to be mounted in an elevated position.

20. The system of claim 19 further comprising:
a tube arranged to be installed in a wall such that an end of the tube extends freely from the wall; and
a beam having a first end configured to fixedly attach to the frame and a second end, opposite to the first end, which is arranged to slide into the free end of the tube to support the ovitrap in an elevated position.

21. A method of mounting an ovitrap, the method comprising:
providing a container arranged to hold a liquid and collect the eggs of a water-breeding insect:
placing the container into a frame arranged to hold the removable container within the frame, the frame comprising an upper opening arranged to receive the container, a substantially annular side wall defining the upper opening with sloping internal side walls such that the internal cross section of the frame decreases with distance from the upper opening, the sloping inner side walls arranged to support the container when received through the upper opening; wherein the method further comprises:
securing the container within the frame with a retainer by moving the retainer between:
an open position, in which the retainer is withdrawn from the container, allowing the container to be removed from the frame; and
a closed position, in which the retainer extends towards and grips the container when the container is in the frame.

22. The method of claim 21 wherein the container comprises a groove extending at least partially around an outer side wall of the container and the step of securing the container within the frame comprises moving the retainer between:
an open position, in which the retainer is withdrawn from the groove of the container, allowing a container held in the frame to be removed; and
a closed position, in which the retainer extends into the groove of the container to prevent a container from being removed from the frame.

23. The method of claim 22 wherein the retainer comprises:
a protrusion arranged to extend into the groove of the container when the retainer is in the closed position; and
an elastic body configured to bend when an outward force is applied to move the protrusion out of the groove in the open position, the elastic body biased to return to the closed position when the force is removed.

24. The method of claim 22 further comprising:
lowering the container into the frame through the upper opening with a holding tool comprising two arms arranged to pass either side of the container to enter the grooves on the opposing sides of the container such that the container can be lifted out of the frame and lowered into the frame via the engagement of the arms of the holding tool with the grooves of the container.

25. The method of claim 24 wherein the protrusion has an angled upper surface and wherein the method further comprises:
lowering the container into the frame such that the container or a holding tool used to hold the container meets the angled upper surface of the protrusion and continued movement of the container into the frame increasingly displaces the retainer to move the retainer into the open position such that the container can be received within the frame.

26. The method of claim 24 wherein the arms of the holding tool each comprise an angled end arranged to meet the retainer when the holding tool is moved into the grooves of the container within the frame; wherein the method comprises:
advancing the arms of the holding tool into the grooves of the container to progressively bend the retainers into the open position;
moving the holding tool upwards to lift the container out of the frame.

27. The method of claim 21 further comprising:
fixedly attaching the frame to a surface.

28. The method of claim 27 further comprising:
fixedly attaching the frame to a beam to mount the ovitrap in an elevated position.

29. The method of claim 28 further comprising:
inserting the beam into a tube installed in the wall to support the ovitrap in an elevated position.

30. The method of claim 21 further comprising:
using an autonomous vehicle or human operator to replace the container.

31. The method of claim 30 further comprising:
using an autonomous vehicle or human operator to operate a holding tool to replace the container.

32. The method of claim 30 further comprising:
sending instructions from the autonomous vehicle to the retainer to move the retainer between the closed and open positions.
